(19) United States
(12) Patent Application Publication
(10) Pub. No.: US 2024/0158680 A1
(43) Pub. Date: May 16, 2024

(54) COMPOSITIONS COMPRISING 2,3,3,3-TETRAFLUOROPROPENE AND OXYGEN-DERIVED OLIGOMERS

(71) Applicant: THE CHEMOURS COMPANY FC, LLC, WILMINGTON, DE (US)

(72) Inventors: SHENG PENG, HOCKESSIN, DE (US); JIAN SUN-BLANKS, ARAB, AL (US); BARBARA HAVILAND MINOR, THE VILLAGES, FL (US); BRIAN E. KIPP, AVONDALE, PA (US); MARY E. KOBAN, CHADDS FORD, PA (US)

(73) Assignee: THE CHEMOURS COMPANY FC, LLC, WILMINGTON, DE (US)

(21) Appl. No.: 18/281,153

(22) PCT Filed: Mar. 8, 2022
(86) PCT No.: PCT/US2022/019285

§ 371 Date: Sep. 8, 2023

Related U.S. Application Data
(60) Provisional application No. 63/158,130, filed on Mar. 8, 2021.

(51) Int. Cl. C09K 5/04; F25D 17/02

(52) U.S. Cl. CPC C09K 5/045; F25D 17/02; C09K 2205/112; C09K 2205/122; C09K 2205/126; C09K 2205/22

(57) ABSTRACT

Disclosed are compositions comprising 2,3,3,3-tetrafluoropropene (HFO-1234yf) and oligomers. Such compositions are useful, among other uses, as heat transfer compositions for use in refrigeration, air-conditioning and heat pump systems.

### CROSS REFERENCE TO RELATED APPLICATIONS

This application is a national filing under 35 U.S.C. 371 of International Application No. PCT/US2022/019285 filed Mar. 8, 2022 and claims the benefit of priority of U.S. Provisional Application No. 63/158,130 filed Mar. 8, 2021, the disclosures of which are incorporated herein by reference in its entirety.

### FIELD

The present invention relates to compositions comprising 2,3,3,3-tetrafluoropropene.

### BACKGROUND

New environmental regulations on refrigerants have forced the refrigeration and air-conditioning industry to look for new refrigerants with low global warming potential (GWP).

Replacement refrigerants are being sought that have low GWP, low toxicity, low or no flammability, reasonable cost and excellent refrigeration performance. Fluoroolefins provide satisfy these criteria. In addition, desired properties in a refrigerant include ease of detecting leaks, performance including efficiency and capacity refrigerant applications, solubility in lubricants used in such applications and compatibility with components used in such applications.

2,3,3,3-Tetrafluoropropene (HFO-1234yf, R-1234yf or 1234yf) is an example of a fluoroolefin having a low Global Warming Potential (GWP) and is an alternative to high GWP hydrofluorocarbons and/or ozone-depleting hydrochlorofluorocarbons in numerous applications such as refrigeration, air-conditioning, heating and cooling, power cycles. Improvement in properties of compositions comprising 1234yf is desired.

### DESCRIPTION OF RELATED ART

Under certain abnormal conditions and in the presence of typically undesired contaminants that could function as an initiator, fluoroolefins may oligomerize or homopolymerize in the presence of certain contaminants that may be present.

WO2019/213004 discloses compositions comprising fluoroolefins and certain inhibitors to increase stability thereof during packaging, storage and usage in refrigeration or air-conditioning system applications.

U.S. Pat. No. 9,428,430 discloses mixing 1234yf with oxygen (3-3,000 by volume ppm). Stability was determined by the amount of solid formed after storage for 20 days at 60° C. Solids formed were identified as 1234yf homopolymer by NMR.

### SUMMARY

The present disclosure provides a composition comprising 2,3,3,3-tetrafluoropropene, and one or more oligomers having a repeat linking unit —{[CF(CF₃)CH₂]ₓ(Oₙ)}_{y}[CF(CF₃)CH₂]_{z}—, where, x, y≥1, n=0, 1 or 2, and z≥0.

The composition may comprise an oligomer having a linking unit chosen from least one of the following: —CF(CF₃)CH₂—CH₂CF(CF₃)—, or —CF(CF₃)CH₂—CF(CF₃)CH₂—, or —CH₂CF(CF₃)—CF(CF₃)CH₂—, or —CF(CF₃)CH₂—O—O—CH₂CF(CF₃)—, or —CF(CF₃)CH₂—O—O—CF(CF₃)CH₂—, or —CH₂CF(CF₃)—O—O—CF(CF₃)CH₂—, or —CF(CF₃)CH₂—O—CH₂CF(CF₃)—, or —CF(CF₃)CH₂—O—CF(CF₃)CH₂—, or —CH₂CF(CF₃)—O—CF(CF₃)CH₂—.

The composition may comprise an oligomer having a linking unit chosen from least one of the following —CF(CF₃)CH₂—CF(CF₃)CH₂—, —CF(CF₃)CH₂—O—O—CH₂CF(CF₃)—, and —CF(CF₃)CH₂—O—O—CF(CF₃)CH₂—.

The oligomer may contain at least one functional end groups such as —CH₂C(═O)CF₃ or —CH₂OH.

The composition may further comprise an additional compound chosen from at least one of HC-40, CFC-12, HFC-23, HFC-134a, HFC-143a, HFC-152a, HCFC-225ca, HCFC-225cb, HFC-244bb, HFC-245cb, HFC-254eb, HFC-263fb, HFO-1123, HFO-1243zf, HFO-1225ye (E- and/or Z-isomer), HFO-1225zc, HFO-1234ze (E- and/or Z-isomer), 3,3,3-trifluoro-1-propyne, HCFO-1233xf, HCFO-1122, HCO-1140, HCFO-1131 (E- and/or Z-isomer), HCFO-1131a, HCFC-124, HCFC-124a, and HCFC-142b.

The composition may further comprise an additional compound chosen from at least one of CHF(CF₃)CH₂CH═CF(CF₃), CHF(CF₃)CH═CHCHF(CF₃), CF(CF₃)═CHCH₂CF(CF₃)CH₂CHF(CF₃), CF₃C(═O)CH₃, formaldehyde, acetaldehyde, trioxane and trifluoroacetic acid.

The composition may further comprise an additional compound chosen from at least one of Z-HFO-1336mzz, E-HFO-1336mzz, HFO-1327mz, HCFO-1122, HCFO-1122a, HFO-1123, E-HFO-1233zd, Z-HFO-1224yd, E-HFO-1132, Z-HFO-1132, HFO-1132a, HCFO-1112, HFO-1234zc, HFO-1234ye, and HFO-1234yc.

The additional compounds are available from commercial suppliers or may be prepared by known methods. The additional compounds may be added in a desired amount. Alternatively, certain of the additional compounds may be co-produced in the methods to produce the composition comprising 2,3,3,3-tetrafluoropropene, and one or more oligomers. If so, the total amount of additional compound may be desirably controlled by purification methods.

The compositions disclosed herein may be useful as heat transfer compositions, aerosol propellants, foaming agents, blowing agents, solvents, cleaning agents, carrier fluids, displacement drying agents, buffing abrasion agents, polymerization media, expansion agents for polyolefins and polyurethane, gaseous dielectrics, extinguishing agents, and fire suppression agents in liquid or gaseous form.

In particular, the compositions disclosed herein are useful in applications as heat transfer compositions. Such applications include use as a refrigerant composition. A refrigerant composition may further comprise a lubricant such as polyol ester (POE), polyalkylene glycol (PAG), polyvinyl ether (PVE) and synthetic hydrocarbon oils. The compositions disclosed herein may improve performance of heat transfer compositions with lubricant in such applications.

Heretofore, as disclosed and/or implied in the prior art, the presence polymers of fluoroolefins in compositions comprising fluoroolefins have been viewed as detrimental to use of the fluoroolefin alone or in compositions comprising the fluoroolefin. The present disclosure surprisingly provides an improved composition for use as a refrigerant or in other heat transfer application wherein the composition comprises a fluoroolefin and a fluoroolefin-containing oligomer. Surprisingly it is now found that adding a fluoroolefin-derived oligomer to a fluoroolefin enhances performance of the resulting composition as a refrigerant or heat transfer composition.

Refrigerant oils lubricants commonly used in compressors, like PAG, POE or PVE are synthetic hydrocarbon oils. The 1234yf oligomer has a saturated hydrocarbon repeating unit [CF(CF₃)CH₂]. The presence of the saturated hydrocarbon segment in the repeating unit is believed to help the solubility of 1234yf and synthetic hydrocarbon oil. In addition, functional end groups (—CH₂C(═O)CF₃ or —CH₂OH) may further increase the compatibility of 1234yf with the refrigerant oil.

### DESCRIPTION

### Compositions

### Oligomer

The present disclosure provides a composition comprising one or more oligomers having a repeating unit of —{[CF(CF₃)CH₂]ₓ(Oₙ)}_{y}[CF(CF₃)CH₂]_{z}—, where x, y≥1, n=0, 1 or 2, and z≥0.

The group —{[CF(CF₃)CH₂]ₓ(Oₙ)}_{y}[CF(CF₃)CH₂]_{z}—, may have a formula chosen from one or more of: —CF(CF₃)CH₂—CH₂CF(CF₃)—, or —CF(CF₃)CH₂—CF(CF₃)CH₂—, or —CH₂CF(CF₃)—CF(CF₃)CH₂—, or —CF(CF₃)CH₂—O—O—CH₂CF(CF₃)—, or —CF(CF₃)CH₂—O—O—CF(CF₃)CH₂—, or —CH₂CF(CF₃)—O—O—CF(CF₃)CH₂—, or —CF(CF₃)CH₂—O—CH₂CF(CF₃)—, or —CF(CF₃)CH₂—O—CF(CF₃)CH₂—, or —CH₂CF(CF₃)—O—CF(CF₃)CH₂—.

In one embodiment, the group —{[CF(CF₃)CH₂]ₓ(Oₙ)}_{y}[CF(CF₃)CH₂]_{z}— has the formula chosen from: —CF(CF₃)CH₂—CH₂CF(CF₃)—, —CF(CF₃)CH₂—O—O—CH₂CF(CF₃)—, and —CF(CF₃)CH₂—O—CH₂CF(CF₃)—.

In one embodiment, the group —{[CF(CF₃)CH₂]ₓ(Oₙ)}_{y}[CF(CF₃)CH₂]_{z}— has the formula chosen from: —CF(CF₃)CH₂—CF(CF₃)CH₂—, —CF(CF₃)CH₂—O—O—CF(CF₃)CH₂—, and —CF(CF₃)CH₂—O—CF(CF₃)CH₂—.

In one embodiment, the group —{[CF(CF₃)CH₂]ₓ(Oₙ)}_{y}[CF(CF₃)CH₂]_{z}— has the formula chosen from: —CH₂CF(CF₃)—CF(CF₃)CH₂—, —CH₂CF(CF₃)—O—O—CF(CF₃)CH₂—, and —CH₂CF(CF₃)—O—CF(CF₃)CH₂—.

The oligomer may contain a functional end group such as a fluoroketone or alcohol group. In one embodiment, the oligomer comprises at least one end group that is —CH₂C(═O)CF₃. In one embodiment, the oligomer comprises at least one end group that is —CH₂OH.

Surprisingly, even when a peroxygen unit is present, the composition is stable, meaning the composition is stable under refrigerant use conditions. Such conditions are known to those skilled in the art. See, for example, ASHRAE Fundamentals Handbook, SI Edition, 2017, Chapter 29, Table 8. See also Chapter 8 of the ASHRAE Handbook discussing refrigerants and providing examples of refrigerant operating conditions, which provides the following.
Low temperature refrigeration: Evaporator −31.7° C., Condenser 30° C.
Medium temperature refrigeration: Evaporator −6.7° C., Condenser 30° C.
   Air conditioning: Evaporator 7.2° C., Condenser 30° C.

The oligomer is soluble in liquid 1234yf (at ambient pressure and temperature) in an amount of at least 3 wt %. In some embodiments the oligomer is soluble in liquid 1234yf in an amount of at least 3.5 wt % or at least 5 wt %. Oligomer and polymer can be determined by ¹⁹F NMR and/or IR/and/or head space GC-MS analysis.

The oligomer is present in the composition in an amount of at least 0.001% by weight (10 ppm). The oligomer is present in the composition in an amount of at least 0.003% by weight (30 ppm). The oligomer is present in the composition in an amount of at least 0.01% by weight (100 ppm). The oligomer is present in the composition in an amount of at least 0.05% by weight (500 ppm). The oligomer is present in the composition in an amount of at least 0.5% by weight (5000 ppm).

The oligomer is present in the composition in an amount up to 1% by weight. The oligomer is present in the composition in an amount up to 0.5% by weight. The oligomer is present in the composition in an amount up to 0.1% by weight.

The amount of oligomer in the composition may range from 0.001% to 1% by weight. The amount of oligomer in the composition may range from 0.001% to 0.5% by weight. The amount of oligomer in the composition may range from 0.001% to 0.1% by weight. The amount of oligomer in the composition may range from 0.01% to 0.5% by weight. The amount of oligomer in the composition may range from 0.01% to 0.1% by weight. A wide range of oligomer concentration is possible based on varying m and n in the formula, which impact the length of the oligomer and hence the size of the oligomer.

### Tetrafluoropropene

The tetrafluoropropene component of the composition is 2,3,3,3-tetrafluoropropene (1234yf), which is commercially available, or can be manufactured by various known processes. A suitable source of 1234yf has a purity (concentration of 1234yf relative to other components) of at least 99.95 wt % or at least 99.9 wt % or at least 99.8 wt % or at least 99.5 wt % or at least 99 wt %.

### Additional Compounds

The composition may further comprise one or more additional compounds. The additional compound may provide improvement in refrigerant performance or some other benefit such as improving compatibility with additives, such as lubricants. An improvement in refrigerant performance may include higher capacity or better efficiency.

The additional compound may be chosen from HC-40, CFC-12, HFC-23, HFC-134a, HFC-143a, HFC-152a, HCFC-225ca, HCFC-225cb, HFC-244bb, HFC-245cb, HFC-254eb, HFC-263fb, HFO-1123, HFO-1243zf, HFO-1225ye (E- and/or Z-isomer), HFO-1225zc, HFO-1234ze (E- and/or Z-isomer), 3,3,3-trifluoro-1-propyne, HCFO-1233xf, HCFO-1122, HCO-1140, HCFO-1131 (E- and/or Z-isomer), HCFO-1131a, HCFC-124, HCFC-124a, and HCFC-142b. These and other additional compounds are recited in Table 1.

The additional compound may be chosen from at least one of CHF(CF₃)CH₂CH═CF(CF₃), CHF(CF₃)CH═CHCHF(CF₃), CF(CF₃)═CHCH₂CF(CF₃)CH₂CHF(CF₃), CF₃C(═O)CH₃, formaldehyde, acetaldehyde, trioxane and trifluoroacetic acid. Certain of these compounds are recited in Table 1.

The composition may further comprise an additional compound chosen from at least one of Z-HFO-1336mzz, E-HFO-1336mzz, HFO-1327mz, HCFO-1122, HCFO-1122a, HFO-1123, E-HFO-1233zd, Z-HFO-1224yd, E-HFO-1132, Z-HFO-1132, HFO-1132a, HCFO-1112, HFO-1234zc, HFO-1234ye, and HFO-1234yc. These compounds are recited in Table 1.

TABLE 1
Additional Compounds

| Compound | Chemical formula | Chemical name |
|---|---|---|
| HFC-32 | CH₂F₂ | difluoromethane |
| HC-40 | CH₃Cl | chloromethane |
| CFC-12 | CCl₂F₂ | dichlorodifluoromethane |
| HFC-23 | CHF₃ | trifluoromethane |
| HCFC-124 | CHClFCF₃ | 1-chloro-1,2,2,2- |
| | | tetrafluoroethane |
| HCFC-124a | CClF₂CHClF₂ | 1-chloro-1,1,2,2- |
| | | tetrafluoroethane |
| HFC-125 | CF₃CHF₂ | pentafluoroethane |
| HFC-134a | CF₃CH₂F | 1,1,1,2-tetrafluoroethane |
| HCFC-142b | CClF₂CH₂ | 1-chloro-1,1-difluoroethane |
| HFC-143a | CF₃CH₃ | 1,1,1-trifluoroethane |
| HFC-152a | CHF₂CH₃ | 1,1-difluoroethane |
| HCFC-225ca | CF₃CF₂CHCl₂ | 3,3-dichloro-1,1,1,2,2- |
| | | pentafluoropropane |
| HCFC-225cb | CF₂ClCF₂CHFCl | 1,3-dichloro-1,1,2,2,3- |
| | | pentafluoropropane |
| HFC-227ea | CF₃CF₂CHF₂ | 1,1,1,2,2,3,3,3- |
| | | heptafluoropropane |
| HFC-236fa | CF₃CH₂CF₃ | 1,1,1,3,3,3-hexafluoropropane |
| HFC-244bb | CF₃CFClCH₃ | 2-chloro-1,1,1,2- |
| | | tetrafluoropropane |
| HFC-245cb | CF₃CF₂CH₃ | 1,1,1,2,2-pentafluoropropane |
| HFC-254eb | CF₃CHFCH₃ | 1,1,1,2-tetrafluoropropane |
| HFC-263fb | CF₃CH₂CH₃ | 1,1,1-trifluoropropane |
| CFO-1112 | CCl₂═CF₂ | 1,1-dichloro-2,2- |
| | | difluoroethylene |
| HCFO-1122 | CF₂═CHCl | 2-chloro-1,1-difluoroethylene |
| HCFO-1122a | CFCl═CFH | 1-chloro-1,2-difluoroethene |
| HFO-1123 | CF₂═CHF | 1,1,2-trifluoroethylene |
| HCFO-1131 | CHCl═CHF | E- and/or Z-1-chloro-2- |
| | | fluoroethylene |
| HCFO-1131a | CClF═CH₂ | 1-chloro-1-fluoroethylene |
| E-HFO-1132 | E-CHF═CHF | 1,2-difluoroethylene |
| Z-HFO-1132 | Z-CHF═CHF | 1,2-difluoroethylene |
| HFO-1132a | CH₂═CF₂ | vinylidene fluoride |
| HCO-1140 | CH₂═CHCl | vinyl chloride |
| HCFO-1224yd | E- and/or Z-CF₃CF═CHCl | 1-chloro-2,3,3,3- |
| | | tetrafluoropropene |
| HFO-1243zf | CF₃CH═CH₂ | 3,3,3-trifluoropropene |
| HFO-1225ye | E- and/or Z-CF₃CF═CHF | E- or Z-1,2,3,3,3- |
| | | pentafluoropropene |
| HFO-1225zc | CF₃CH═CF₂ | 1,1,3,3,3-pentafluoropropene |
| HFO-1234ze | E- and/or Z-CF₃CH═CHF | E- or Z-1,3,3,3- |
| | | tetrafluoropropene |
| | CH≡CCF₃ | 3,3,3-trifluoro-1-propyne |
| HFO-1234zc | CHF₂CH═CF₂ | 1,1,3,3-tetrafluoro-1 propene |
| HFO-1234ye | CHF═CFCHF₂ | 1,1,2,3-tetrafluoropropene |
| HFO-1234yc | CH₂FCF═CF₂ | 1,1,2,3-tetrafluoro-1-propene |
| HCFO-1233xf | CF₃CCl═CH₂ | 2-chloro-3,3,3-trifluoropropene |
| HCFO-1233zd | E- and/or Z-CF₃CH═CHCl | E- and/or Z-1-chloro-3,3,3- |
| | | trifluoropropene |
| HFO-1327mz | CF₃CF═CHCF₃ | 1,1,1,2,4,4,4-heptafluoro-2- |
| | | butene |
| HFO-1336mzz | E- and/or Z-CF₃CH═CHCF₃ | E- and/or Z-1,1,1,4,4,4- |
| | | hexafluoro-2-butene |
| HFO- | CHF(CF₃)CH₂CH═CF(CF₃) | 1,1,1,2,5,6,6,6-octafluoro-2- |
| 1558mefzy | | hexene |
| HFO- | CHF(CF₃)CH═CHCHF(CF₃) | 1,1,1,2,5,6,6,6-octafluoro-3- |
| 1558mezze | | hexene |
| HFO-187- | CF(CF₃)═CHCH₂CF(CF₃)CH₂CHF(CF₃) | 1,1,1,5,7,8,8,8-octafluoro-5- |
| 12mefmyfzy | | trifluoromethyl-2-octene |

It is desired that the additional compound maintains the composition's global warming potential (GWP) less than 1500 or less than 750 or less than 150. The additional compound may lower the GWP of the composition to less than 4, which is the GWP of 1234yf. For example, certain hydrofluoroolefins (HFOs) have a GWP of less than 4, such as HFO-1243zf, which has a GWP of less than 1.

In one embodiment of the present disclosure, the additional compound may be chosen from one or more of HFO-1243zf, HFC-134a, HCFO-1122, HFC-254eb, HCFC-124 and HFC-23. In one embodiment, the additional compound is a combination of HFO-1243zf, HFC-134a and HFC-143a. In one embodiment, the additional compound is a combination of HFO-1243zf, HFC-134a, HFC-143a, HCFO-1122 and HFC-254eb.

In one embodiment of the present disclosure, the additional compound may be chosen from one or more of HFC-152a, HFO-1234ze(E), HCFO-1131a, HCO-1140, CFC-12, HFC-244bb and HCFO-1233xf. In one embodiment, the additional compound is a combination of HFC-152a and HFO-1234ze(E). In one embodiment, the additional compound is a combination of HFC-152a, HFO-1234ze(E), HCFO-1131a, HCO-1140, HFC-244bb and HCFO-1233xf.

In one embodiment of the present disclosure, the additional compound may be chosen from one or more of HFO-1225ye(Z), HC-40, HFO-1123 and HFC-263fb. In one embodiment, the additional compound is chosen from a combination of HFO-1225ye(Z), HFO-1123 and HFC-263fb.

In one embodiment, the additional compound is a minor component of the composition. In such an embodiment, the amount of an additional compound may be greater than 0 wt % and less than 1 wt %. The total amount of additional compounds present may be greater than 0.1 ppm and less than 0.5 wt % of the total weight of the composition. The total amount of additional compounds present may be greater than 1 ppm and less than 0.1 wt % of the total weight of the composition. The total amount of additional compounds present may be greater than 10 ppm or greater than 100 ppm or greater than 1000 ppm. The total amount of additional compounds may be less than 1 wt % or less than 0.5 wt % or less than 0.1 wt %. In one embodiment, the total amount of additional compounds is less than 1 wt %, such that the amount of 1234yf is at least 99%, or the total amount of additional compounds is less than 0.5%, such that the amount of 1234yf is at least 99.5%.

### Inhibitor

The composition may further comprise an inhibitor. The inhibitor may be a hydrocarbon comprising at least one of cyclic monoterpenes lipophilic organic compounds including tocopherols such as α-tocopherol; phenols, aromatic organic compounds having at least one chemical moiety C₆H₄(OH) including benzene-1,4-diol, to fluoroolefin containing refrigerant compositions will increase the stability thereof during packaging, storage and usage in refrigeration or air-conditioning system applications. Specific examples of inhibitor compounds may be chosen from limonene, α-terpinene, pinene (alpha, beta), α-tocopherol, butylated hydroxytoluene, 4-methoxyphenol, benzene-1,4-diol. In one embodiment, the inhibitor comprises α-terpinene.

In one embodiment, the composition comprises limonene or α-terpinene optionally with an anti-oxidant having a unique fragrance even at a few ppm level. This pleasant odor can be utilized for leakage detection of the composition, for example, in heat transfer applications. This is especially beneficial for early refrigerant leakage detection in household air conditioner or mobile air conditioner as paraprofessional electronic leak detectors often are not available in either location.

While any suitable amount of inhibitor may be employed, effective amounts comprise from 0.001 wt % to 10 wt %, 0.01 wt % to 5 wt %, 0.3 wt % to 4 wt %, 0.3 wt % to 1 wt % based on the total weight of the composition. In one embodiment, an effective amount comprises 10 to 2000 ppm or 10 to 1000 ppm or 10 to 500 ppm of at least one inhibitor.

### Anti-Oxidant

One embodiment of the invention relates to a composition as disclosed herein further comprising at least one anti-oxidant. While any suitable oxidant can be employed, examples of suitable oxidants comprise at least one member selected from the group consisting of butylated hydroxytoluene, butylated hydroxyanisole, tertiary-butylhydroquinone, gallate, 2-phenyl-2-propanol, 1-(2,4,5-trihydroxyphenyl)-1-butanone, bisphenol methane derivatives, 2,2′-methylene bis (4-methyl-6-t-butyl phenol), among other phenolics, and combinations thereof.

### Preparation of the Composition

The present disclosure provides a composition comprising 1234yf and one or more oligomers having a repeating unit of —{[CF(CF₃)CH₂]ₓ(Oₙ)}_{y}[CF(CF₃)CH₂]_{z}—, where, x, y≥1, n=0, 1 or 2, and z≥0.

The composition may be prepared by contacting 1234yf with a source of oxygen at a contact time and contact temperature. Optionally one or more of the additional compounds may be present during the contacting step. Examples of what may be used as an oxygen source to prepare the composition disclosed herein include oxygen-containing gases such as oxygen (100%) and air. Alternatively, the oxygen source may be in combination with peroxygen compound such as fluoroolefin polyperoxide, peroxides, hydroperoxides, persulfates, percarbonates, perborates and hydropersulfates. An example of a hydroperoxide is cumene hydroperoxide. A readily available oxygen source is air.

In the preparation of the composition, the oxygen source has an oxygen (O₂) concentration of at least 0.01% oxygen or at least 21% oxygen or pure (100%) oxygen, by weight. The contact time is at least 3 days or at least 14 days. The contact temperature is in the range of −25 to 150° C. It will be appreciated by those skilled in the art that the oxygen concentration, contact time and contact temperature are interdependent. That is, as one of the oxygen concentration, contact time and temperature increases, the others will decrease.

Air is the preferred oxygen source for its availability and cost. The oxygen source may remain present in the composition after the composition has been prepared in an amount from greater than zero wt % up to 10,000 ppm.

The additional compounds may be added prior to or following the above-recited contacting step.

Similarly, the inhibitor and/or anti-oxidant may be present in the composition comprising 1234yf and optionally the one or more additional compounds prior to the above-recited contacting step. The inhibitor and/or anti-oxidant may be added following the above-recited contacting step.

### Applications

The compositions disclosed herein have a variety of utilities including working fluids, which include blowing agents, aerosol propellants, sterilants or, heat transfer mediums (such as heat transfer fluids and refrigerants for use in refrigeration systems, refrigerators, air conditioning systems, heat pumps, chillers, and the like), among others. The compositions are particularly suited for use in mobile air conditioning and heating systems and as a component for making a refrigerant blend for use in stationary refrigeration, air-conditioning and heat pump systems.

A blowing agent is a volatile composition that expands a polymer matrix to form a cellular structure.

An aerosol propellant is a volatile composition of one or more components that exerts a pressure greater than one atmosphere to expel a material from a container.

A sterilant is a volatile biocidel fluid or blend containing a volatile biocidel fluid that destroys a biologically active material or the like.

### Heat Transfer Applications

A heat transfer fluid (also referred to herein as a heat transfer composition or heat transfer fluid composition) is a working fluid used to carry heat from a heat source to a heat sink.

The present disclosure further relates to a process for transfer of heat from a heat source to a heat sink wherein the compositions disclosed herein serve as heat transfer fluids. Said process for heat transfer comprises transporting a composition comprising 2,3,3,3-tetrafluoropropene, and one or more oligomers having a repeating linking unit of —{[CF(CF₃)CH₂]ₓ(Oₙ)}_{y}[CF(CF₃)CH₂]_{z}—, where, x, y≥1, n=0, 1 or 2, and z≥0 from a heat source to a heat sink.

A heat source is defined as any space, location, object or body from which it is desirable to add, transfer, move or remove heat. In one embodiment a heat source is a body to be cooled. In one embodiment, a heat source is a body to be heated.

In some embodiments, the heat transfer composition may remain in a constant state throughout the transfer process (i.e., not evaporate or condense). In other embodiments, evaporative cooling processes may utilize heat transfer compositions as well.

A heat sink may be defined as any space, location, object or body capable of absorbing heat. A vapor compression refrigeration system is one example of such a heat sink.

A body to be cooled may be any space location or object (the space location or object may be open or enclosed), requiring refrigeration or cooling. In stationary applications the body may be the interior of a structure, such as a residential or commercial structure requiring air-conditioning, industrial water chillers, or a storage location such as refrigerator or freezer cases in a supermarket, transport refrigerated containers other storage locations for perishables, such as food or pharmaceuticals. In mobile applications, the body may be incorporated into a transportation unit for the road, rail, sea or air, such as the passenger compartment of an automobile requiring air conditioning.

Certain refrigeration systems operate independently with regards to any moving carrier, these are known as “intermodal” systems. Such intermodal systems include “containers” (combined sea/land transport) as well as “swap bodies” (combined road and rail transport).

A body to be heated may be any space, location or object requiring heat. These may be the interior of structures either residential or commercial structures requiring heating, in a similar manner to the body to be cooled. Additionally, mobile units as described for cooling may be similar to those requiring heating. Certain transport units require heating to prevent the material being transported from solidifying inside the transport container.

A heat transfer system is a system (or apparatus) used to produce a heating or cooling effect in a particular space. A heat transfer system may be a mobile system or a stationary system. According to the disclosure herein, there is provided a heat transfer system comprising a composition comprising 2,3,3,3-tetrafluoropropene, and one or more oligomers having a repeating linking unit of —{[CF(CF₃)CH₂]ₓ(Oₙ)}_{y}[CF—(CF₃)CH₂]_{z}—, where, x, y≥1, n=0, 1 or 2, and z≥0. In one embodiment, the heat transfer system is a stationary system chosen from a refrigeration, air-conditioning or heat pump apparatus. In one embodiment, the heat transfer system is a mobile system which is a mobile air-conditioning system.

A refrigerant is defined herein as a heat transfer fluid which undergoes a phase change from liquid to gas and back again during a cycle used to transfer of heat. There is provided herein a refrigerant comprising 2,3,3,3-tetrafluoropropene, and one or more oligomers having a repeating linking unit of —{[CF(CF₃)CH₂]ₓ(Oₙ)}_{y}[CF(CF₃)CH₂]_{z}—, where, x, y≥1, n=0, 1 or 2, and z≥0. In one embodiment, the refrigerant further comprises a lubricant. In one embodiment, the refrigerant comprises one or more added refrigerants (as defined hereinbelow).

The present disclosure further relates to a method for producing heating comprising evaporating a refrigerant comprising 2,3,3,3-tetrafluoropropene, and one or more oligomers having a repeating linking unit of —{[CF(CF₃)CH₂]ₓ(Oₙ)}_{y}[CF(CF₃)CH₂]_{z}—, where, x, y≥1, n=0, 1 or 2, and z≥0, and thereafter condensing said composition in the vicinity of a body to be heated. In one embodiment of this method, the refrigerant further comprises a lubricant.

The present disclosure further provides a method for producing cooling comprising condensing a refrigerant comprising 2,3,3,3-tetrafluoropropene, and one or more oligomers having a repeating linking unit of —{[CF(CF₃)CH₂]ₓ—(Oₙ)}_{y}[CF(CF₃)CH₂]_{z}—, where, x, y≥1, n=0, 1 or 2, and z≥0, and thereafter evaporating said composition in the vicinity of a body to be cooled. In one embodiment of this method, the refrigerant further comprises a lubricant.

The present disclosure further provides a method for producing heating or cooling in a refrigeration, air-conditioning, or heat pump apparatus, said method comprising introducing a refrigerant into said apparatus having (a) a centrifugal compressor; (b) a multi-stage centrifugal compressor, or (c) a single slab/single pass heat exchanger; wherein said refrigerant or heat transfer fluid composition comprises a composition comprising 2,3,3,3-tetrafluoropropene, and one or more oligomers having a repeating linking unit of —{[CF(CF₃)CH₂]ₓ(Oₙ)}_{y}[CF(CF₃)CH₂]_{z}—, where, x, y≥1, n=0, 1 or 2, and z≥0. In one embodiment of this method, the refrigerant further comprises a lubricant.

### Lubricant

The lubricant component of the refrigerant compositions can comprise those suitable for use with refrigeration or air-conditioning apparatus. Among these lubricants are those conventionally used in compression refrigeration apparatus utilizing chlorofluorocarbon refrigerants. Such lubricants and their properties are discussed in the 1990 ASHRAE Handbook, Refrigeration Systems and Applications, chapter 8, titled “Lubricants in Refrigeration Systems”, pages 8.1 through 8.21, herein incorporated by reference. These include mineral oils and synthetic oils.

Mineral oils comprise paraffins (i.e. straight-chain and branched-carbon-chain, saturated hydrocarbons), naphthenes (i.e. cyclic or ring structure saturated hydrocarbons, which may be paraffins) and aromatics (i.e. unsaturated, cyclic hydrocarbons containing one or more rings characterized by alternating double bonds).

Synthetic oils comprise alkylaryls (i.e. linear and branched alkyl alkylbenzenes), synthetic paraffins and naphthenes, silicones, and poly-alpha-olefins.

The lubricant component may comprise those which have been designed for use with hydrofluorocarbon refrigerants and are miscible with compositions disclosed herein under compression refrigeration and air-conditioning apparatus' operating conditions. Such lubricants and their properties are discussed in “Synthetic Lubricants and High-Performance Fluids”, R. L. Shubkin, editor, Marcel Dekker, 1993. Such lubricants include, but are not limited to, polyol esters (POEs) such as Castrol® 100 (Castrol, United Kingdom), polyalkylene glycols (PAGs) such as RL-488A from Dow (Dow Chemical, Midland, Michigan), and polyvinyl ethers (PVEs).

Lubricants for applications disclosed herein are selected by considering a given compressor's requirements and the environment to which the lubricant will be exposed. In one particular embodiment, the foregoing refrigerant compositions are combined with a PAG lubricant for usage in an automotive A/C system having an internal combustion engine. In another particular embodiment, the foregoing refrigerant compositions are combined with a POE lubricant for usage in an automotive NC system having an electric or hybrid electric drive train.

### Added Refrigerants

In other embodiments, a refrigerant composition comprises 2,3,3,3-tetrafluoropropene and one or more oligomers having a repeating linking unit of —{[CF(CF₃)CH₂]ₓ(Oₙ)}_{y}[CF(CF₃)CH₂]_{z}—, where, x, y≥1, n=0, 1 or 2, and z≥0 and one or more added refrigerants. In one embodiment an added refrigerant comprises a hydrofluorocarbon. Examples of suitable hydrofluorocarbons include difluoromethane (HFC-32), pentafluoroethane (HFC-125), 1,1,1,2-tetrafluoroethane (HFC-134a), 1,1-difluoroethane (HFC-152a), 1,1,1,3,3,3-hexafluoropropane (HFC-236fa) and 1,1,1,2,2,3,3,3-heptafluoropropane (HFC-227ea). The refrigerant composition may comprise 2,3,3,3-tetrafluoropropene and one or more oligomers having a repeating linking unit of —{[CF(CF₃)CH₂]ₓ(Oₙ)}_{y}[CF(CF₃)CH₂]_{z}—, where, x, y≥1, n=0, 1 or 2, and z≥0 and one or more added refrigerants, and a lubricant.

In one particular embodiment, the added refrigerant comprises HFO-1234ze. In another embodiment, the added refrigerant comprises carbon dioxide.

The amount of added refrigerant can range from 10 to 90 wt %, 25 to 75 wt %, 30 to 60 wt % or 30 to 50 wt %.

### Refrigerant Additives

Additives which can improve the refrigerant and NC lifetime and compressor durability are desirable. In one aspect of the invention, the inventive refrigerant composition is used to introduce lubricant into the NC system as well as other additives, such as a) acid scavengers and b) flame suppressants.

### Acid Scavenger

An acid scavenger may comprise a siloxane, an activated aromatic compound, or a combination of both. Serrano et al. (paragraph 38 of US 2011/0272624 A1) disclose that the siloxane may be any molecule having a siloxy functionality. The siloxane may include an alkyl siloxane, an aryl siloxane, or a siloxane containing mixtures of aryl and alkyl substituents. For example, the siloxane may be an alkyl siloxane, including a dialkylsiloxane or a polydialkylsiloxane. Preferred siloxanes include an oxygen atom bonded to two silicon atoms, i.e., a group having the structure: SiOSi. Preferred siloxanes include siloxanes of having one or more of methyl, ethyl, propyl, or butyl groups.

In one aspect of the invention, the siloxane is an alkylsiloxane containing from about 1 to about 12 carbon atoms, such as hexamethyldisiloxane. The siloxane may also be a polymer such as polydialkylsiloxane, where the alkyl group is a methyl, ethyl, propyl, butyl, or any combination thereof. Suitable polydialkylsiloxanes have a molecular weight from about 100 to about 10,000. Highly preferred siloxanes include hexamethyldisiloxane, polydimethylsiloxane, and combinations thereof. The siloxane may consist essentially of polydimethylsiloxane, hexamethyldisiloxane, or a combination thereof.

The activated aromatic compound may be any aromatic molecule activated towards a Friedel-Crafts addition reaction, or mixtures thereof. An aromatic molecule activated towards a Friedel-Crafts addition reaction is defined to be any aromatic molecule capable of an addition reaction with mineral acids. Especially aromatic molecules capable of addition reactions with mineral acids either in the application environment (AC system) or during the ASHRAE 97: 2007 “Sealed Glass Tube Method to Test the Chemical Stability of Materials for Use within Refrigerant Systems” thermal stability test.

The acid scavenger (e.g., the activated aromatic compound, the siloxane, or both) may be present in any concentration that results in a relatively low total acid number, a relatively low total halides concentration, a relatively low total organic acid concentration, or any combination thereof. Preferably the acid scavenger is present at a concentration greater than about 0.0050 wt %, more preferably greater than about 0.05 wt % and even more preferably greater than about 0.1 wt % (e.g. greater than about 0.5 wt %) based on the total weight of the refrigerant composition. The acid scavenger preferably is present in a concentration less than about 3 wt %, more preferably less than about 2.5 wt % and most preferably greater than about 2 wt % (e. g. less than about 1.8 wt %) based on the total weight of the refrigerant composition.

### Flame Suppressants

Preferred flame suppressants include those described in patent application “Refrigerant compositions containing fluorine substituted olefins CA 2557873 A1” and incorporated by reference along with fluorinated products such as HFC-125 and/or Krytox® lubricants, also incorporated by reference and described in patent application “Refrigerant compositions comprising fluoroolefins and uses thereof WO2009018117A1.”

### Preparation of Refrigerant Composition

The refrigerant compositions of the present invention may be prepared by any convenient method to combine the desired amount of the individual components. A preferred method is to weigh the desired component amounts and thereafter combine the components in an appropriate vessel. Agitation may be used, if desired.

### EXAMPLES

### Example 1

A sample of 60 g of 2,3,3,3-tetrafluoropropene having purity of 99.5 wt % and containing 1243zf, 1234ze, 152a was added to a 500 mL cylinder containing 12,000 ppm air. The cylinder was left for six months at ambient temperature conditions that varied from −5° C. to 35° C.

Analyses of samples taken from the cylinder were performed using NMR and/or FTIR. The analysis confirmed the presence of 0.2 wt % of oxygen-containing oligomer of 2,3,3,3-tetrafluoropropene. The analyses were further confirmed by one or more of the following tests: peroxide test, GC-MS and nitrogen and oxygen ratio examination in non-condensable gas analysis of samples from the cylinder.

1. A composition comprising 2,3,3,3-tetrafluoropropene, and one or more oligomers having a repeating linking unit of —{[CF(CF₃)CH₂]ₓ(Oₙ)}_{y}[CF(CF₃)CH₂]_{z}—, where, x, y≥1, n=1 or 2, and z≥0.

2. The composition of claim 1 comprising an oligomer having a linking unit chosen from least one of the following: —CF(CF₃)CH₂—O—O—CH₂CF(CF₃)—, or —CF(CF₃)CH₂—O—O—CF(CF₃)CH₂—, or —CH₂CF(CF₃)—O—O—CF(CF₃)CH₂—, or —CF(CF₃)CH₂—O—CH₂CF(CF₃)—, or —CF(CF₃)CH₂—O—CF(CF₃)CH₂—, or —CH₂CF(CF₃)—O—CF(CF₃)CH₂—.

3. The composition of claim 1 wherein the composition further comprises an additional compound chosen from HC-40, CFC-12, HFC-23, HFC-134a, HFC-143a, HFC-152a, HCFC-225ca, HCFC-225cb, HFC-244bb, HFC-245cb, HFC-254eb, HFC-263fb, HFO-1123, HFO-1243zf, HFO-1225ye (E- and/or Z-isomer), HFO-1225zc, HFO-1234ze (E- and/or Z-isomer), 3,3,3-trifluoro-1-propyne, HCFO-1233xf, HCFO-1122, HCO-1140, HCFO-1131 (E- and/or Z-isomer), HCFO-1131a, HCFC-124, HCFC-124a, and HCFC-142b.

4. The composition of claim 1 wherein the linking unit has the formula —CF(CF₃)CH₂—O—O—CH₂CF(CF₃)—, —CF(CF₃)CH₂—O—O—CF(CF₃)CH₂—, —CF(CF₃)CH₂—O—CH₂CF(CF₃)—, or —CF(CF₃)CH₂—O—CF(CF₃)CH₂—.

5. The composition of claim 1 wherein the oligomer is present in the composition in an amount of at least 0.001% by weight (10 ppm).

6. The composition of claim 1 wherein the oligomer is present in the composition in an amount of at least 0.01% by weight (100 ppm).

7. The composition of claim 1 wherein the composition further comprises an additional compound chosen from one or more of HFO-1243zf, HFC-134a, HFC-143a, HCFO-1122, HFC-254eb, HCFC-124 and HFC-23.

8. The composition of claim 7 wherein the additional compound is a combination of HFO-1243zf, HFC-134a and HFC-143a.

9. The composition of claim 7 wherein the additional compound is a combination of HFO-1243zf, HFC-134a, HFC-143a, HCFO-1122 and HFC-254eb.

10. The composition of claim 1 wherein the composition further comprises an additional compound chosen from one or more of HFC-152a, HFO-1234ze(E), HCFO-1131a, HCO-1140, CFC-12, HFC-244bb and HCFO-1233xf.

11. The composition of claim 1 wherein the composition further comprises an additional compound chosen from one or more of HFO-1225ye(Z), HC-40, HFO-1123 and HFC-263fb.

12. The composition of claim 1 wherein the composition further comprises an additional compound chosen from at least one of CHF(CF₃)CH₂CH═CF(CF₃), CHF(CF₃)CH═CHCHF(CF₃), CF(CF₃)═CHCH₂CF(CF₃)CH₂CHF(CF₃), CF₃C(═O)CH₃, formaldehyde, acetaldehyde, trioxane and trifluoroacetic acid.

13. The composition of claim 1 wherein the composition further comprises an additional compound chosen from at least one of Z-HFO-1336mzz, E-HFO-1336mzz, HFO-1327mz, HCFO-1122, HCFO-1122a, HFO-1123, E-HFO-1233zd, Z-HFO-1224yd, E-HFO-1132, Z-HFO-1132, HFO-1132a, HCFO-1112, HFO-1234zc, HFO-1234ye, and HFO-1234yc.

14. The composition of claim 3 wherein the total amount of additional compound is greater than 0 wt % and less than 1 wt %.

15. The composition of claim 3 wherein the total amount of additional compounds present is greater than 0.1 ppm and less than 0.5 wt % of the total weight of the composition.

16. The composition of claim 1 wherein the composition further comprises an inhibitor.

17. The composition of claim 16 wherein the inhibitor is chosen from limonene, α-terpinene, α-pinene, β-pinene, α-tocopherol, butylated hydroxytoluene, 4-methoxyphenol, benzene-1,4-diol.

18. The composition of claim 17 wherein the composition comprises limonene or α-terpinene or α-pinene or β-pinene.

19-24. (canceled)

25. A process for heat transfer comprising transporting a composition comprising the composition of claim 1 from a heat source to a heat sink.

26-28. (canceled)

29. A heat transfer system comprising the composition of claim 1

30. The system of claim 29 wherein the heat transfer system is a stationary system chosen from a refrigeration, air-conditioning or heat pump apparatus.

31. The heat transfer system of claim 29, wherein the heat transfer system is a mobile system which is a mobile air-conditioning system.
